(19) United States
(12) Patent Application Publication
(10) Pub. No.: US 2025/0353419 A1
(43) Pub. Date: Nov. 20, 2025

(54) IN-CAR STEERING WHEEL MOUNTED CONVENIENCE DEVICE

(71) Applicant: Lenny Herrin, Elkins Park, PA (US)

(72) Inventor: Lenny Herrin, Elkins Park, PA (US)

(21) Appl. No.: 18/831,329

(22) Filed: Nov. 20, 2024

Related U.S. Application Data
(60) Provisional application No. 63/603,216, filed on Nov. 28, 2023.

(51) Int. Cl. B60N 3/00

(52) U.S. Cl. CPC B60N 3/00

(57) ABSTRACT

A convenience device comprising a plurality of segments formed on a flat foldable material that when formed according to fold lines on the material becomes a three-dimensional convenience device for suspension from a steering wheel within a vehicle, said convenience device comprising a hanger segment comprising a cutout for fitting over the steering wheel to enable the device to be suspended from the steering wheel, a back segment extending between the hanger segment and the shelf segment, and a shelf segment comprising sides and a front rail segment for containment of items placed on the shelf segment.

The present application claims priority from provisional application No. 63/603,216 filed Nov. 28, 2023.

### BACKGROUND OF THE INVENTION

Most vehicle operators have faced the dilemma of juggling several items on their dashboards, in their laps, in both hands, or on the seat while attempting to eat or handle a business task. Often, the items in question wind up on the floor of the vehicle or spilled on the occupant. The present invention addresses that problem by providing a stable surface to rest the items upon so that juggling is unnecessary. The items may be food obtained from a drive-through window or notes, reference materials and other business-related things for use during a phone call. The present invention provides an easily used and stored convenience device that is suspended from the vehicle steering wheel to free the occupant's hands from the need to corral several items at a time.

### SUMMARY OF THE INVENTION

A new convenience device for use in a vehicle to facilitate support of food items on a simple structure that enables the vehicle occupant to easily arrange the food items for handling and consumption. The invention enables the vehicle occupant to avoid juggling food items on her person or other surfaces within the vehicle after acquiring food items from a fast-food establishment or drive-thru window. The device may also be useful for a person conducting business from a vehicle, in that notes, business cards, appointments, and other papers may be arranged on the device while the person makes and receives phone calls or digital messages.

A vehicle convenience device for suspension from a steering wheel comprising a hanger segment, a shelf segment, and a back segment; said hanger segment comprising a cutout for fitting over the steering wheel to enable the device to be suspended from the steering wheel, said back segment extending between the hanger segment and the shelf segment, and said shelf segment comprising sides and a front rail segment for containment of items placed on the shelf segment.

### BRIEF DESCRIPTION OF THE DRAWINGS

FIG. 1 is a plan view of a pre-assembly form of the invention.

FIG. 2 is a plan view of an alternative embodiment of a pre-assembly form of the present invention.

FIG. 3 is a three-dimensional view of the assembled form of the invention corresponding to FIG. 2.

### DESCRIPTION OF THE INVENTION

The exemplary embodiment of the present invention is a steering wheel-mounted tray on which may be placed food items for consumption while sitting in the vehicle, particularly in the drivers' seat. The tray may be comprised of a single sheet of material stamped out of or otherwise cut from a blank. The exemplary embodiment of the device may be folded into its final form, various tabs and surfaces being secured by familiar means such that the device becomes sufficiently rigid to support a typical fast food meal upon it. Reference to the accompanying drawings illustrates the form, operation and use of the exemplary embodiment of the invention.

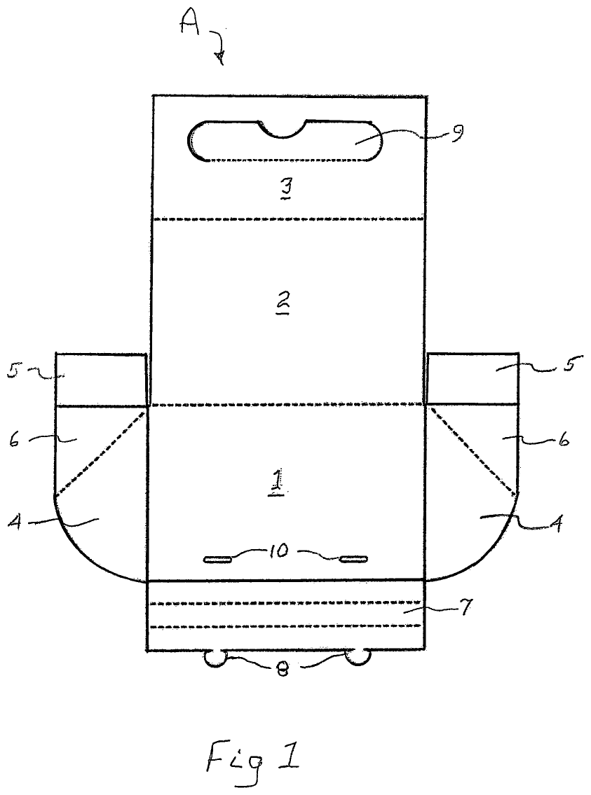

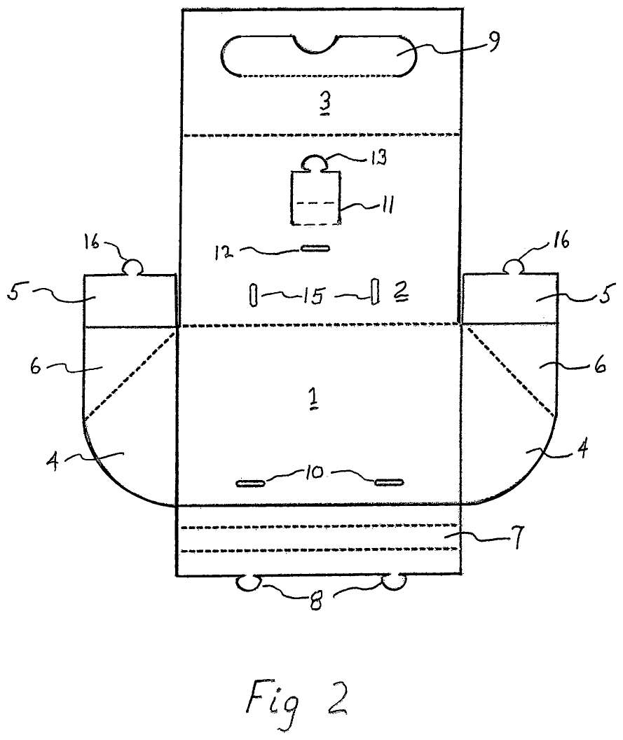

Referring to FIG. 1, a single element of material A may be stamped or otherwise cut from a blank (not shown) in the indicated shape. Material element A may be marked with fold lines (dashed lines in FIGS. 1 and 2) that facilitate the assembly of element A into the usable form of the invention. Said fold lines may comprise stamped indents, perforations or other indicia to assist in forming the single element A into a unitary structure that will support food items on its surface.

The device A comprises four major segments. A first segment becomes the shelf 1 of the device when assembled. A second segment becomes an upright back 2 that extends from a hanger segment 3 down to the shelf 1. The hanger segment 3 is folded into a horizontal position extending away from the vehicle occupant. The hanger segment 3 has a cutout 9 that fits over the steering wheel of a vehicle, suspending the device A in position in front of the driver. The upright 2D back 2 of the device extends from the hanger 3 and supports the shelf 1. Thus positioned, the shelf 1 is conveniently located to hold food items in orderly fashion.

The shelf 1 is bounded by two sides 4 and a front rail 7 to contain items within the shelf 1 area. The front rail 7 is a fourth major segment of the device that folds twice along the indicated lines toward the shelf 1 forming a raised barrier. Front rail 7 comprises tabs 8 that fit into slots 10 in the shelf 1 to secure the rail 7 in place. Sides 4 fold upward and comprise flaps 5 that fold inward for securing against the back 2 of the device A. Flaps 5 may be secured to the upright back 2 of the device by common means to provide rigidity to the device structure. With the flaps 5 secured the sides 4 are held perpendicular to the shelf 1 for containment of items on the shelf.

The assembled device further comprises side segments 6 differentiated from sides 4 by fold lines as shown. These folds permit the shelf 1 of the assembled device to be folded up away from the user for convenience whenever it may be necessary to move the shelf. The side fold lines indicate where the sides 4,6 fold inward as the shelf 1 is raised. When the shelf 1 returns to its normal horizontal configuration, the sides 4,6 once again provide containment on both sides of the shelf 1.

Reference to FIG. 2 illustrates an alternative embodiment of the invention wherein each of the elements common with FIG. 1 remain as described. An additional feature is represented by a small support 11 that is initially disposed flat on the upright back 2. The support 11 comprises a tab 13 and may be folded along the indicated fold line such that the tab 13 engages a slot 12 in the back 2. This presents a small support surface 11 extending toward the user from the back 2 of the device A. Said support surface 11 may be employed to stand a mobile digital device, such as a mobile phone or small tablet, or notes and other reference material directly in front of the user.

In FIG. 2, the flaps 5 are depicted with tabs 16 that illustrate one common way of securing the flaps 5 to the back 2 of the device A. Slots 15 are provided in the back 2 for insertion of the tabs 16 such that flaps 5 are affixed to the back 2 when the sides 4 are folded up to enclose the shelf 1. Other means, such as adhesive or various shapes of engagement elements, are also within the scope of the invention.

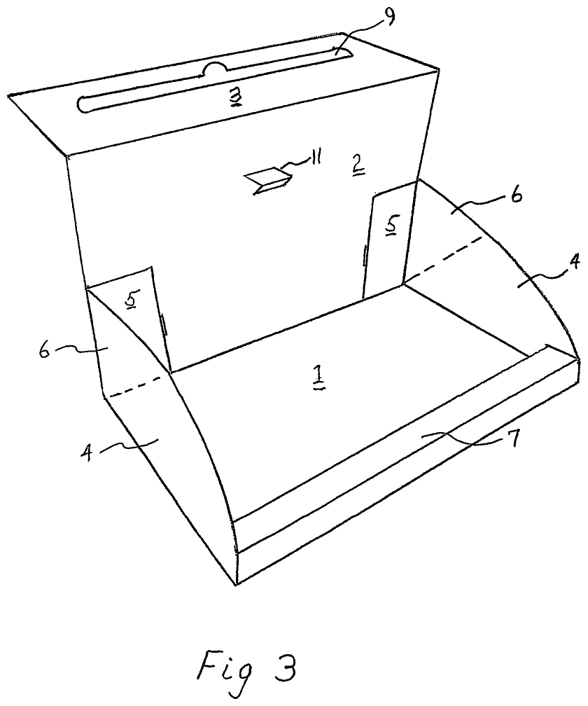

Reference to FIG. 3 shows the device A configured for use in a vehicle. As described, the hanger segment 3 has been folded away from the user positioning mounting cutout 9 for slipping over the top of the steering wheel (not shown). The upright back 2 extends vertically between the hanger segment 3 and the shelf 1. The shelf 1 is folded upward perpendicular to the back 2 and extends toward the user. Items on the shelf 1 are contained by sides 4, 6 on either side of the shelf 1, and by the folded front rail 7. Tabs 16 have engaged slots 15 (see FIG. 2) to secure the flaps 5 in place.

The embodiment shown in FIG. 3 illustrates the support 11 that was initially disposed flat upon the back extended for its purpose. The support 11 in FIG. 3 has been folded out and down and the tab 13 (see FIG. 2) has been inserted into slot 12 (see FIG. 2). This arranges support 11 substantially perpendicular to the back 2 providing a shelf upon which a digital device, for example, may be placed while eating or talking on a phone.

Various materials may be employed to construct the device A. The most economical is likely to be cardboard of sufficient strength to retain its shape and support characteristics once a load such as an order of food items is placed on the shelf 1. Alternatives such as light plastics or metals are also possible.

Certain variations of the elements and features of the invention are possible within the scope of the invention. Reference to the following claims is necessary to determine the legal scope of the invention according to the applicant.

I claim:

1. A vehicle convenience device for suspension from a steering wheel comprising a hanger segment, a shelf segment, and a back segment;
said hanger segment comprising a cutout for fitting over the steering wheel to enable the device to be suspended from the steering wheel,
said back segment extending between the hanger segment and the shelf segment,
and said shelf segment comprising sides and a front rail segment for containment of items placed on the shelf segment.

2. The vehicle convenience device of claim 1, further comprising flaps extending from said sides, said flaps when folded inward overlap and secure to the back segment.

3. The vehicle convenience device of claim 1, said front rail segment comprising three sections folded toward the shelf segment and having tabs to secure the folded sections to the shelf.

4. The vehicle convenience device of claim 3, said shelf segment comprising slots to engage the tabs of the front rail segment.

5. The vehicle convenience device of claim 2, said flaps comprising tabs to secure the flaps to the back segment.

6. The vehicle convenience device of claim 5, said back segment comprising slots disposed to engage the tabs on the flaps.

7. The vehicle convenience device of claim 1, further comprising a support disposed on the back segment and having one or more tabs for engaging one or more slots in the back segment of the device.

8. The vehicle convenience device of claim 7, said support forming a support surface protruding from the back segment.

9. A convenience device comprising a plurality of segments formed on a flat foldable material that when formed according to fold lines on the material becomes a three-dimensional convenience device for suspension from a steering wheel within a vehicle, said convenience device comprising
a hanger segment comprising a cutout for fitting over the steering wheel to enable the device to be suspended from the steering wheel,
a back segment extending between the hanger segment and the shelf segment,
and a shelf segment comprising sides and a front rail segment for containment of items placed on the shelf segment.

10. The convenience device of claim 9, further comprising
flaps extending from said sides, said flaps when folded inward overlap and secure to the back segment.

11. The convenience device of claim 10, said front rail segment comprising three sections folded toward the shelf segment and having tabs to secure the folded sections to the shelf.

12. The convenience device of claim 11, said shelf segment comprising slots to engage the tabs of the front rail segment.

13. The convenience device of claim 10, said flaps comprising tabs to secure the flaps to the back segment.

14. The convenience device of claim 13, said back segment comprising slots disposed to engage the tabs on the flaps.

15. The convenience device of claim 9, further comprising a support disposed on the back segment and having one or more tabs for engaging one or more slots in the back segment of the device.

16. The vehicle convenience device of claim 15, said support forming a support surface protruding from the back segment.
